(19) United States
(12) Patent Application Publication
(10) Pub. No.: US 2005/0010024 A1
(43) Pub. Date: Jan. 13, 2005

(54) Method for the production of tubes in composite materials

(76) Inventors: Jorg Volle, Selm-Bork (DE); Wolfgang Scherzer, Bergkamen (DE)

Correspondence Address: PROSKAUER ROSE LLP;PATENT DEPARTMENT, 1585 BROADWAY, NEW YORK, NY, 10036-8299, US

(21) Appl. No.: 10/491,552

(22) PCT Filed: Sep. 20, 2002
(86) PCT No.: PCT/EP02/10576

(30) Foreign Application Priority Data
Oct. 8, 2001 (DE) 101 49 555.2

(51) Int. Cl. C08G 65/04

(52) U.S. Cl. 528/421

(57) ABSTRACT

Method of producing pipes and pipe auxiliary pieces for pipeline systems in composite material, especially for service water and drinking water, produced by the filament winding process with binders based on epoxy resins containing on average more than one epoxide group in the molecule and on curing agents for the epoxy resins, with the use of customary auxiliaries and additives, characterized in that as binder a curable composition comprising a) a liquid epoxy resin having epoxide values of from 0.40 to 0.65 and b) an adduct of a triethylenetetraminoimidazoline with a glycidyl ether having more than one epoxide group per molecule is used.

The invention relates to a method of producing pipes and pipe accessory pieces in composite materials for pipeline systems, especially for service water and drinking water, produced by the filament winding process from customary insert materials with binders based on epoxy resins and, as curing component, adducts of triethylenetetraminoimidazolines with glycidyl ethers containing more than one epoxide group per molecule.

The metal pipes which are still used predominantly today have a number of deficiencies in their properties, such as, in particular, high weight and susceptibility to corrosion. Every year immense sums are expended on the maintenance, renovation or replacement of water-carrying pipes in the low-temperature sector (drinking water, service water), but especially where hot water or steam is to be piped in or out.

For a considerable time, therefore, increased efforts have been made to make it possible to utilize the positive properties of fibre-reinforced synthetic resins for this field, such as low weight, a good chemical resistance—including in certain circumstances resistance to solvents—and also adaptability with regard to construction requirements, economic production as compared with other corrosion-resistant materials such as glass, metal and enamel, and low servicing and maintenance costs.

The endeavours to utilize the positive properties of fibre-reinforced synthetic resins for producing pipes as well which are intended for use in the supply of drinking water and service water at relatively high temperatures have therefore been further intensified.

In the course of these endeavours it has become apparent that their commercial utilization in the drinking water sector is opposed in particular by the physiological unacceptability of the curing agents which are customary in the filament winding sector, as well as by certain processing problems.

In the supplying of hot water or steam up to about 120° C. a reduction in the level of thermal properties, in the torsion pendulum test to DIN 53 445, for example, was recorded after a relatively short time.

As a result of the reduction in the level of thermal properties, the construction properties of the fibre-reinforced composite materials are adversely affected, in some case to such an extent that they cannot be used for the abovementioned applications.

A curing agent which does have the physical property requirements imposed is 1-amino-3,3,5-trimethyl-5-aminomethylcyclohexane (isophoronediamine).

Isophoronediamine, however, is a curing agent having a number of processing drawbacks. Attention should be drawn here in particular to the short processing time, the high curing temperature required, and physiological problems.

In the past, therefore, there has been no lack of attempts to develop alternative curing agents which generate properties comparable with those of isophoronediamine in the cured resins and which give rise to lesser physiological problems.

Although the use of imidazolines based on reaction products of monomeric fatty acids and polyethylene polyamines did provide physiological acceptability, it did not provide adequate resistance to hot water, as is evident from the sharp drop in the HDT (heat distortion temperature) values following storage in boiling water.

Values found from practical experience show that not only the imidazolines formed from short-chain monocarboxylic acids but also, surprisingly, the imidazolines formed from the hydrophobic long-chain monomeric and dimeric fatty acids are capable of absorbing relatively large amounts of water. There is a corresponding drop in the HDT values. In the case of cycloaliphatic diamines such as isophoronediamine this is not the case.

According to general belief, therefore, imidazolines as curing agents for epoxy resins are unsuitable for products which are to be subsequently subjected to a water load.

Surprisingly it has now been found that adducts of triethylenetetraminoimidazolines with glycidyl ethers containing more than one epoxide group per molecule endow the cured epoxy resins based on bisphenol A and bisphenol F both with physiological acceptability and with resistance to a permanent load of hot water or hot steam up to about 120° C. Moreover, the processing properties are improved as well: in particular it has been possible to extend the open time to levels which are in accordance with practice.

The invention accordingly provides a method of producing pipes and pipe accessory pieces for pipeline systems in composite material, especially for service water and drinking water, produced by the filament winding process with binders based on epoxy resins which contain on average more than one epoxide group in the molecule, and on curing agents for the epoxy resins, with the use of customary auxiliaries and additives, characterized in that as binder a curable composition comprising
a) a liquid epoxy resin having epoxide values of from 0.40 to 0.65 and
b) an adduct of a triethylenetetraminoimidazoline with a glycidyl ether having more than one epoxide group per molecule is used.

The epoxy resins a) used in accordance with the invention are glycidyl ethers having on average more than one epoxide group per molecule, such as, preferably, the glycidyl ethers based on monohydric or polyhydric phenols. In accordance with the invention preference is given to glycidyl ethers of 2,2-bis(4-hydroxyphenyl)propane (bisphenol A) having epoxide values of 0.45-0.65, particularly to the compounds which are liquid at room temperature and have epoxide values in the range from 0.5 to 0.61. Additionally, the glycidyl ethers based on bisphenol F and the novolaks have also proved to be advantageous.

The imidazoline adducts b) of the invention are prepared by condensing triethylenetetramine with carboxylic acids in a molar ratio of preferably 1:1. Carboxylic acids preferably with 2-4 carbon atoms are used, both alone and in mixtures, particularly acetic acid and/or propionic acid. Subsequently the imidazolines are adducted with glycidyl ethers containing more than one epoxide group per molecule. Preference here is given to bisphenol A and to bisphenol F diglycidyl ether. The level of adduction depends on the desired performance properties and also on the desired viscosity of the imidazoline adduct. Positive properties are generally obtained when from 0.05 to 0.5, preferably from 0.1 to 0.3, more preferably 0.2 epoxide equivalent is adducted per mole of imidazoline compound.

If desired it is also possible, in order to modify the processing properties and curing properties, to make use of the modifiers which are customary and are common knowledge in this field, such as customary fillers and/or reinforcing materials, pigments, dyes, accelerators, wetting agents, levelling agents, reactive diluents and curing agents. Reinforcing materials used with preference are the customary glass fibres.

Customary curing agents which may be used addiotionally are in particular the cycloaliphatic amines such as, for example, isophoronediamine, 1,2-diaminocyclohexane and 4,4′-diamino-3,3′-dimethyldicyclohexylmethane.

Reactive diluents which can be used in accordance with the invention are preferably glycidyl ethers based on alicyclic alcohols such as 1,4-dimethylolcyclohexane and on aliphatic alcohols, especially dihydric or trihydric aliphatic alcohols having 4-8 carbon atoms, such as butanediols, hexanediols, octanediols and glycerol, which can be extended by addition reaction with ethylene oxide or propylene oxide, and also glycidyl ethers based on phenol or cresol.

The amount of the reactive diluents is generally between 5-10%, preferably 6-8% by weight, based on the epoxy resin a).

Owing to the relatively long Tecam time of the curing agents used in accordance with the invention it is possible to set tailored pot lives by controlled addition of accelerators which are customary in this field.

Accelerators which can be used include, for example, tertiary amines, such as those based on phenol-formaldehyde condensation products.

The comparatively high viscosities of the curing agents used in accordance with the invention make it possible to adapt the processing viscosity individually as well to the requirements of practice. In the case of heatable impregnating baths and cores this can be done simply by an appropriate choice of temperature or, in the case of other cores, which are not heatable, by using reactive diluents. This allows an infinite adjustment, thereby making it possible to obtain optimum wetting of the reinforcing material without the binder being squeezed out, and dripping, during the winding operation, i.e., when the mandrel is being built up. In addition to the reduction in binder losses it is also possible for the build-up of the mandrel to take place more uniformly.

In pipe manufacture by the filament winding process continuous fibres provided with binder are deposited continuously on a rotating core, which determines the internal diameter of the pipe. The pipe walls are built up here in layers, by first depositing the impregnated fibres alongside one another over the entire pipe length, as in the case of a bobbin, before winding the next ply over the first in the same way. The thickness of the winding and the deposition angle of the fibres perpendicularly to the axis of the pipe are dependent on the subsequent internal pipe pressure, although for manufacturing reasons two successive plies always have a slightly different wind angle. When the desired pipe wall thickness has been reached the mandrel along with the core is subjected to a heat treatment in order to cure the still-liquid binder and is subsequently demoulded from the core.

In order to produce high-quality pipes by the filament winding process it is important that the binder wets the reinforcing fibres as fully as possible but without the binder dripping from the mandrel as it is being built up, as a result of inadequate impregnating viscosity. Moreover, the resin system is required to have a sufficiently long gelation time so that one wound ply has not already reacted before the following ply has been applied, which would result in a deleterious weakening in the wound assembly as a whole. Furthermore, a short gelation time in the resin system makes the whole manufacturing operation more difficult, since it rules out the use of easily managed impregnating baths for binder application to the reinforcing fibres and instead necessitates continuous binder metering, with which, however, the risk of metering and mixing errors also increases considerably. Since, on the other hand, the mandrel is to react as quickly as possible on exposure to temperature after it has been completed, the gelation time ought as far as possible to be optimally adaptable to the duration of the particular winding operation.

As shown by Table 1, the gelation time of the binder systems with the curing agents according to Example 1 and 2 is well above the comparison value of the binder system used with preference at present in the pipe winding sector, containing the curing agent corresponding to Example 3. The values from the tensile test and the level of properties under temperature load of Example 1 and, in particular, of Example 2 also markedly exceed the data for Example 3 under the preferred conditions of 2 h/120° C.; particularly noteworthy are the high transition temperatures of 182° C. and 189° C. (Example 1 and 2 respectively) as against 158° C. (Example 3).

Of particular significance is the change in the level of properties of the binder systems on uniform temperature and water exposure, as is clear from Table 2 on the basis in the change of the HDT values after different periods of storage in boiling water.

As shown by Table 2 for Example 4, the HDT value for binder systems cured with standard imidazolines falls sharply under this loading after 7 days of temperature and water exposure. In the case of the imidazoline adducts according to Example 1 and 2 used in accordance with the invention, in contrast, the reduction in HDT on exposure to boiling water is very limited.

The curable compositions of the invention described above can also be used for producing parts whose desired shape means that they cannot be produced directly by the filament winding process.

Further provided, therefore, is the use of a curable composition comprising
a) a liquid epoxy resin having epoxide values of from 0.40 to 0.65 and
b) an adduct of a triethylenetetraminoimidazoline with a glycidyl ether having more than one epoxide group per molecule for producing pipeline accessory pieces for pipeline systems and containers in composite material, especially for service water and drinking water.

### EXAMPLES

### Example 1

146 g (1 mol) of triethylenetetramine are charged to a reaction vessel. 74 g (1 mol) of propionic acid are added with stirring over the course of approximately 1 h so as to produce a homogeneous mixture. The temperature rises to about 80° C. The addition is followed by heating; condensation begins starting from about 160° C. The temperature is slowly raised to 270° C. and held at that temperature until no further distillate passes over. About 34 g of distillate are obtained. The imidazoline content—determined by infrared spectroscopy—is about 80%.

After the product has been cooled to about 60° C. 38 g (0.2 epoxide equivalent) of a bisphenol A diglycidyl ether having an epoxide value of about 0.525 equivalent/100 g are added with stirring over the course of 30 minutes to the 186 g (≈1 mol) of the imidazoline that remain in the reaction vessel.

The resultant reaction product has the following characteristics: viscosity at 25° C.: 2150 mPa·s; amine number: 952 mg KOH/g.

### Example 2

In accordance with Example 1 an imidazoline adduct is prepared from 146 g (1 mol) of triethylenetetramine, 60 g (1 mol) of acetic acid and 38.8 g (0.2 epoxide equivalent) of a bisphenol F diglycidyl ether having an epoxide value of 0.61 equivalent/100 g.

### Example 3

Standard commercial isophoronediamine.

### Example 4

In accordance with Example 1 an imidazoline is prepared from 103 g of diethylenetetramine (1 mol) and 74 g of propionic acid (1 mol).

Test Procedure:

In order to determine the level of mechanical properties, 15 parts by weight of curing agent in the case of Examples 1, 2 and 4 and, respectively, 25 parts by weight of curing agent in the case of Example 3 are mixed with in each case 100 parts by weight of a low-viscosity epoxy resin based on bisphenol A (epoxide value: 0.54) and the mixture is cured in a steel mould at 120° C. in 2 hours to form planar mouldings 4 mm thick. By sawing and/or milling, samples are then taken from these mouldings, and the property values listed in Table 1 below are determined on these samples, observing the respective test standards. The specimen dimensions utilized in the various tests are as follows: for a 3-point flexural test: 80×10×4 mm; for a tensile test: dumbbell No. 3 to DIN 53455; for HDT: 120×10×4 mm.

TABLE 1
Properties of the binder systems after curing at 120° C. for 2 h:

| | Ex- | Ex- | Ex- | Ex- |
|---|---|---|---|---|
| Property | ample 1 | ample 2 | ample 3 | ample 4 |
| Tecam gelation time: 250 g | 200 | 185 | 115 | 280 |
| at 23° C. [min] | | | | |
| Flexural strength [N/mm²] | 100 | 112 | 102 | 97 |
| Tensile strength [N/mm²] | 64 | 69 | 45 | 49 |
| Elongation (DIN 53455) [%] | 3.0 | 2.8 | 1.9 | 3.8 |
| Heat distortion temperature [° C.] | 135 | 137 | 123 | 125 |
| Transition temperature [° C.] | 182 | 189 | 158 | 145 |
| (DIN 53445) | | | | |

TABLE 2
HDT values of different binder systems
after storage in boiling water:

| | Storage time in boiling water | | | | |
|---|---|---|---|---|---|
| | 0 value | 1 day | 2 days | 3 days | 7 days |
| Example 1 | 135 | 129 | 129 | 127 | 127 |
| Example 2 | 137 | 132 | 133 | 131 | 130 |
| Example 3 | 123 | 118 | 118 | 117 | 117 |
| Example 4 | 125 | 110 | 101 | 95 | 80 |

TABLE 3
H₂O absorption on 100° H₂O storage:

Storage time in days

| | 1 day | 2 days | 3 days | 7 days |
|---|---|---|---|---|
| Example 1 | 2.2% | 2.5% | 3.1% | 3.6% |
| Example 2 | 2.3% | 2.7% | 3.4% | 3.9% |
| Example 3 | 1.8% | 2.0% | 2.4% | 2.8% |
| Example 4 | 2.9% | 3.8% | 4.5% | 5.8% |

1-10. (Canceled).

11. Method of producing pipes and pipe auxiliary pieces for pipeline systems in composite material, especially for service water and drinking water, produced by the filament winding process with binders based on epoxy resins containing on average more than one epoxide group in the molecule and on curing agents for the epoxy resins, with the use of customary auxiliaries and additives, wherein as binder a curable composition comprising
a) a liquid epoxy resin having epoxide values of from 0.40 to 0.65 and
b) an adduct of a triethylenetetraminoimidazoline with a glycidyl ether having more than one epoxide group per molecule is used.

12. Method according to claim 11, wherein a liquid bisphenol A resin and/or bisphenol F resin is used as epoxy resin a).

13. Method according to claim 11, wherein the epoxy resin a) has an epoxide value of from 0.45 to 0.65.

14. Method according to claim 11, wherein the epoxy resin a) has an epoxide value of from 0.50 to 0.61.

15. Method according to claim 11, wherein a reactive diluent is also used.

16. Method according to claim 11, wherein a lower aliphatic carboxylic acid having 2 to 4 carbon atoms is used as carboxylic acid for preparing the triethylenetetraminoimidazoline.

17. Method according to claim 16, wherein acetic and/or propionic acid is used as carboxylic acid.

18. Method according to claim 11, wherein a diglycidyl ether of bisphenol A and/or bisphenol F is used for adducting the triethylenetetraminoimidazoline b).

19. Method according to claim 11, wherein from 0.05 to 0.5 epoxide equivalents of the epoxy resin are used for adduct formation per mole of the triethylenetetraminoimidazoline.

20. Method according to claim 11, wherein from 0.15 to 0.3 epoxide equivalents of the epoxy resin are used for adduct formation per mole of the triethylenetetraminoimidazoline.

21. Method according to claim 11, wherein the imidazoline content of the triethylenetetraminoimidazoline is at least 50 mol %.

22. Method according to claim 11, wherein the imidazoline content of the triethylenetetraminoimidazoline is at least 70 mol %.
